(19) United States
(12) Patent Application Publication
(10) Pub. No.: US 2023/0065477 A1
(43) Pub. Date: Mar. 2, 2023

(54) IMPROVEMENTS TO FLUID ROTORS WITH ADJUSTABLE VANES

(71) Applicants: ADV TECH, Merignac (FR); ADV PROPULSE, Merignac (FR)

(72) Inventor: Arnaud CURUTCHET, Merignac (FR)

(21) Appl. No.: 17/995,726

(22) PCT Filed: Apr. 12, 2021
(86) PCT No.: PCT/IB2021/052999

§ 371 Date: Oct. 7, 2022

(30) Foreign Application Priority Data
Apr. 10, 2020 (FR) 2003668

(51) Int. Cl. F03D 3/06

(52) U.S. Cl. CPC F03D 3/068; F05B 2260/72

(57) ABSTRACT

What is proposed is a rotor with adjustable vanes, comprising a rotary structure rotating about a main axis and comprising a set of vanes rotating about a series of vane axes parallel to the main axis and defined by said rotary structure, and a mechanism associated with each vane and configured to control the variations in inclination of the associated vane according to the angular position of the rotary structure, this mechanism comprising a first element (65) supporting a pin (64) and a second element which is eccentric with respect to the first and configured to channel the movements of the pin along an imposed path.

According to the invention, said path is imposed by the translational movements of a carriage (62) along one or more guides (61) provided on the second element.

### FIELD OF THE INVENTION

The present invention generally relates to fluid rotors, in particular rotors with movement of trochoidal-type vanes.

### PRIOR ART

Such rotors are known from documents WO2014006603A1, WO2016067251A1 and WO2017168359A1.

This disclosure aims to bring a certain number of improvements to these rotors.

### SUMMARY OF THE INVENTION

According to a first aspect, a rotor with adjustable vanes is proposed, comprising a rotary structure rotating about a main axis and comprising a set of vanes rotating about a series of vane axes parallel to the main axis and defined by said rotary structure, and a mechanism associated with each vane and configured to control the variations in inclination of the associated vane according to the angular position of the rotary structure, this mechanism comprising a first element supporting a pin and a second element that is eccentric with respect to the first and configured to channel the movements of the pin along an imposed path, the rotor being characterized in that said path is imposed by the translational movements of a carriage along one or more guides provided on the second element (PART 6).

Advantageously, the carriage is mounted on two rods.

Also advantageously, the carriage is mounted on the guide(s) by means of play-free sliding elements, in particular ball bearings.

According to a second aspect, a rotor with adjustable vanes is proposed, comprising a rotary structure rotating about a main axis and comprising a set of vanes rotating about a series of vane axes parallel to the main axis and defined by said rotary structure, and a mechanism configured to control the variations in inclination of the vanes according to the angular position of said structure, according to a setting law, said mechanism comprising, for each vane, a transmission in a generally radial direction between a driving element rotating with the rotor and a driven element driven eccentrically at the vane, characterized in that it comprises means for varying the setting law by means of a central control comprising a control element able to move along the main axis and a set of return elements able to generate a displacement of the driven elements respectively associated with each vane (PART 1).

Said displacement may in particular be a sequentially controlled radial displacement or a continuously controlled circumferential displacement.

According to a third aspect, a watercraft is proposed, comprising a pair of main thrusters comprising counter-rotating rotors, each rotor with adjustable vanes comprising a rotary structure rotating about a main axis and comprising a set of vanes rotating about a series of vane axes parallel to the main axis and defined by said rotary structure, and a mechanism for controlling the variations in inclination of said rotary structure according to its angular position so as to exert thrust on the water in a determined direction, characterized in that means are provided for directing the thrust of the two rotors in two generally opposite lateral directions in order to ensure braking of the vehicle (PART 2).

The vehicle may also optionally comprise at least one bow thruster and/or at least one secondary thruster.

According to a fourth aspect, a watercraft is proposed, comprising a pair of thrusters comprising counter-rotating rotors, each rotor comprising a rotary structure rotating about a main axis and comprising a set of vanes rotating about a series of vane axes parallel to the main axis and defined by said rotary structure, and a mechanism for controlling the variations in inclination of said rotary structure according to its angular position so as to exert thrust on the water in a determined direction, characterized in that thrust correction means are provided that are capable of adjusting the thrust direction of each rotor on either side of a direction located along the main axis of the vehicle (PART 3).

According to a fifth aspect, a rotor with adjustable vanes is proposed, comprising a rotary structure rotating about a main axis and comprising a set of vanes rotating about a series of vane axes parallel to the main axis and defined by said rotary structure, and a mechanism for controlling the variations in inclination of said rotary structure according to its angular position, characterized in that each vane is at least partially elastically deformable (PART 4).

Advantageously but optionally, each vane comprises an essentially non-deformable leading part and an elastically deformable trailing part.

According to a sixth aspect, a rotor with adjustable vanes is proposed, comprising a rotary structure rotating about a main axis and comprising a set of vanes rotating about a series of vane axes parallel to the main axis and defined by said rotary structure, and a mechanism for controlling the variations in inclination of said rotary structure according to its angular position, said mechanism comprising, in association with each vane, a driven element synchronized with a corresponding driving element located on the axis of the rotor via a link closed on itself such as a toothed belt or a chain, characterized in that one of the elements is circular, and the other element is non-circular, with a number of notches or teeth identical to that of the circular element, so as to directly ensure variations in the angular position of the vanes during the rotation of the rotary structure (PART 5).

Advantageously but optionally, the other element is elliptical.

The rotor may optionally comprise a tensioning device for the link.

The rotor may also optionally comprise a set of non-circular elements of different aspect ratios, and a device for passing the link from one non-circular element to another.

This rotor can in particular equip a wind turbine or propel a watercraft, individually or in pairs.

According to a seventh aspect, a rotor with adjustable vanes is proposed, comprising a rotary structure rotating about a main axis and comprising a set of vanes rotating about a series of vane axes parallel to the main axis and defined by said rotary structure, and a mechanism associated with each vane for controlling the variations in inclination of said vane according to the angular position of said rotary structure, said mechanism comprising a set of generally radial transmissions between driving elements arranged adjacent to the axis of the rotor and each of said mechanisms, characterized in that it further comprises a release and resetting mechanism comprising a key able to move along the axis of the rotor with respect to said driving elements (PART 7).

In a first possible embodiment, said release mechanism comprises a key able to selectively come into direct engagement with each of the driving elements and urged by an elastic means acting along the axis of rotation of the rotor to sequentially come into engagement with each of said driving elements when they are rotated.

In a second possible embodiment, said release mechanism comprises a main key capable of selectively urging a set of secondary keys that in turn are elastically urged in a direction transverse to the axis of the rotor and respectively come into engagement with the respective drive elements.

A rotor with adjustable vanes is also proposed, comprising a rotary structure rotating about a main axis and comprising a set of vanes rotating about a series of vane axes parallel to the main axis and defined by said rotary structure, and means for controlling the variations in inclination of each vane according to the angular position of the rotor, characterized in that said means comprise a set of individual actuators controlled non-mechanically from the rotor to vary individually in a potentially adjustable manner and potentially program the pitch variations of the associated vane (PART 8).

According to a ninth aspect, a rotor with adjustable vanes is proposed, comprising a rotary structure rotating about a main axis and comprising a set of vanes rotating about a series of vane axes parallel to the main axis and defined by said rotary structure, and a mechanism for controlling the variations in inclination of said rotary structure according to its angular position, said mechanism comprising, in association with each vane, a driven element synchronized with a corresponding driving element located on the axis of the rotor via a link closed on itself such as a toothed belt or a chain, characterized in that it comprises a mechanism for holding each link under tension (PARTS 9 AND 10).

In one embodiment, said tension holding mechanism comprises a movable element in contact with said link and subjected to the centrifugal force generated by the rotation of the rotor (PART 9).

In another embodiment, the tension holding mechanism comprises a movable element in contact with said link and subject to a movable member aimed at varying the maximum amplitude of the variations in inclination of the associated vane (PART 10).

According to a tenth aspect, a watercraft, in particular a sailboat, is proposed, comprising an engine coupled to an immersed rotor with adjustable vanes, said rotor comprising a rotary structure rotating about a main axis and comprising a set of vanes rotating about a series of vane axes parallel to the main axis and defined by said rotary structure, and a mechanism for controlling the variations in inclination of said rotary structure according to its angular position, characterized in that the rotor has a first operating mode as a thruster while being driven by the engine, and a second drift or rudder operating mode (PART 11).

According to an eleventh aspect, a rotor with adjustable vanes is proposed, comprising a rotary structure rotating about a main axis and comprising a set of vanes rotating about a series of vane axes parallel to the main axis and defined by said rotary structure, and a mechanism for controlling the variations in inclination of each vane according to the angular position of said rotary structure, each vane being mounted cantilevered on said rotary structure, characterized in that quick mounting devices are provided for mounting the vanes on rotary supports subject to said mechanism (PART 12).

Advantageously but optionally, each vane comprises an armature of non-circular cross-section extending over a substantial part of its extent, said armature projecting at a longitudinal end of the vane for mounting thereof on a respective rotary support.

Finally, according to a thirteenth aspect, a rotor with adjustable vanes is proposed, comprising a rotary structure rotating about a main axis and comprising a set of vanes rotating about a series of vane axes parallel to the main axis and defined by said rotary structure, and a mechanism for controlling the variations in inclination of said rotary structure according to its angular position, said mechanism comprising, in association with each vane, a driven element synchronized with a driving element located on the axis of the rotor via a link closed on itself such as a toothed belt or a chain, characterized in that a single link is provided between a single driving element located on the axis of the rotor and said driven elements (PART 13).

### BRIEF DESCRIPTION OF THE DRAWINGS

Other aspects, objects and advantages of the inventions will appear better on reading the following detailed description of preferred embodiments, given by way of example and done with reference to the appended drawings. In the drawings:

FIG. 1A is a perspective view of a mechanism according to a first improvement,

FIGS. 1B and 1C are perspective views from two different angles of a mechanism according to another embodiment of this first improvement,

FIG. 2 is a schematic top view of a watercraft comprising a second improvement,

FIGS. 3A and 3B are schematic top views of thrusters illustrating a third improvement,

FIGS. 4A and 4B are perspective views of a vane with a fourth improvement,

FIG. 5 is a schematic plane view of a motion transmission according to a fifth improvement,

FIG. 6A to 6C are respectively a front view, a side view and a perspective view of a mechanism according to a sixth improvement,

FIGS. 7A and 7B are perspective views of a mechanism according to a seventh improvement,

FIGS. 7C and 7D are views in axial section of a mechanism according to another embodiment of this seventh improvement,

FIG. 8 is a schematic elevational view illustrating an eighth improvement,

FIG. 9 is a perspective view of a mechanism according to a ninth improvement,

FIG. 10A to 10C are respectively an elevation view in a first state, an elevation view in a second state and a perspective view of a mechanism according to a tenth improvement,

FIG. 11 is a schematic side view of a boat with a thruster according to an eleventh improvement,

FIG. 12 is a perspective view of a base according to a twelfth improvement, and

FIG. 13 is a front view of a transmission according to a thirteenth improvement.

### DETAILED DESCRIPTION OF PREFERRED EMBODIMENTS

Part 1— Propulsion Mode—Variation of the Setting Law

Document WO2017168359A1, the content of which is incorporated here by reference, describes the possibility of varying the setting law of a rotor used in thruster mode as a function of the speed. The setting angle is defined by the direction of the fore/aft axis of the vane with respect to the tangent to the circular movement of the vane.

It is first of all necessary to introduce the notion of forward speed A: this is defined as the speed of the ship in relation to the speed that the vane sees in its rotation. The higher the setting angle, the higher the thrust, the lower the forward speed. The more the setting angle decreases, the lower the thrust, but the more the forward speed increases, also with the efficiency. For example, with a setting of 10°, we can approach efficiencies of 80% at forward speeds λ of 2.5: this means that the ship is going twice as fast as the vane; in other words, under these conditions the thruster rotates very slowly to move the boat forward, which results in reduced cavitation and a very low acoustic signature. For example, a thruster of 3m20 in diameter would rotate at only 31 rpm to move a ship forward at 25 knots (Nb: forward speed of 2.5). It will be easily understood that it is particularly relevant to be able to control the setting of the thruster in real time because this makes it possible to optimize operation and consumption: high setting in the start-up phases of the ship (or take-off on an airplane or on a VTOL) to maximize thrust, and lower setting to pick up speed. This can be done manually or more advantageously with an automaton that will take as input: speed of the ship, RPM of the thruster(s), consumption (power or torque). Finally, being able to set the pitch to zero makes it possible to erase the vanes as much as possible, which, for example in a thruster application on a sailboat, makes it possible to slow down the sailboat less when sailing while keeping a possibility of directivity because each vane is thus transformed into a rudder (the pitch can be at zero, but steering control is retained—see also part 11).

Remember that real-time pitch adjustment is very relevant in the energy harvesting application, for example to regulate the power in the wind turbine application to manage storm situations. It is known that the greater the setting angle (for example, 50°), the greater the efficiency (Cp: coefficient of performance) with a TSR (Tip Speed Ratio: defines the speed of rotation of the rotor versus the windspeed) close to 1. The lower the setting angle, the more the Cp decreases, along with the TSR. As on wind turbines with conventional variable-pitch propellers, it is therefore very relevant, once the maximum power of the generator has been reached, to reduce the setting angle so as to regulate the power up to the disengagement speed, typically located at 25 m/s.

To achieve real-time setting control, it is necessary to be able to vary the position of the slotted disc (cf. WO2017168359A1) relative to the axis of rotation of the vane. When these axes are aligned, the setting is at 0°. The further apart they are, the greater the setting angle. It is preferred to vary the position of the axis of rotation of the slotted disc.

This can be done as described in WO2017168359A1 either according to a radius of the rotor, or via a variation owing to an eccentric at the end of the arm (these first two solutions being the most suitable for large-diameter rotors), or according to an arc of a circle, a preferred solution on smaller-diameter rotors, for example for ship thrusters.

In the first case, the difficulty comes from how the movement is transmitted to the slotted disc from the central control axis of the rotor. If belts or chains are used, it is necessary to be able to maintain an optimal tension, which requires control of the tensioning system. In the case of gears, it is necessary to vary the position of the intermediate gear. In the case of an angle transmission drive, it is possible to use a pinion with splines, which can slide along the transmission shaft (see also later at the end of PART 10).

The second solution is simpler because by varying along an arc of a circle, the distance between the axis of rotation of the slotted disc and the center of the thruster is not modified. This last solution will therefore be preferred.

Two approaches will now be described.

### A—Sequential-Type Mechanical Approach

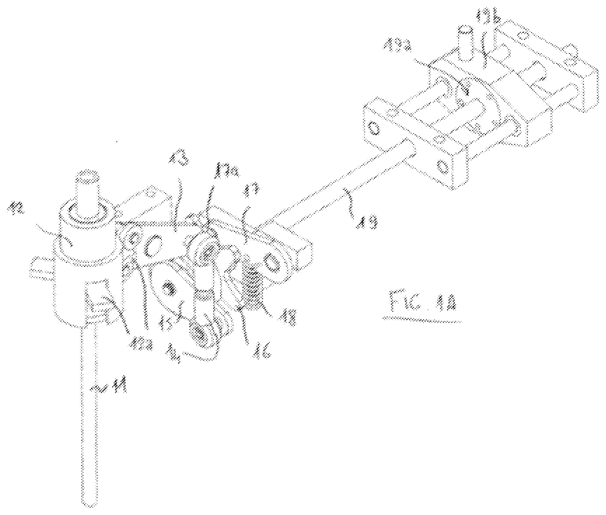

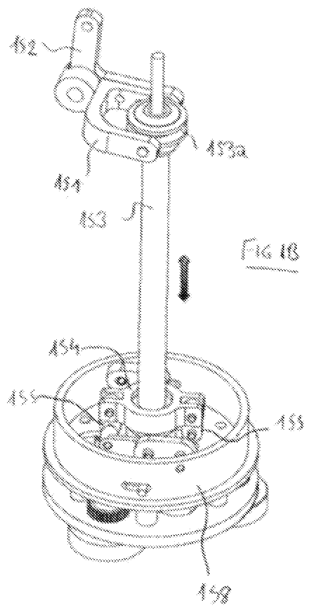

With reference to FIG. 1A, a description will be given of a mechanism inspired by the sequential controls of motorcycle gearboxes. A control shaft 11 extending along the axis of the rotor is actuated in translation by an actuator (electric, mechanical, pneumatic, hydraulic) not shown in this drawing. The control shaft is fixed in rotation and therefore does not rotate with the rotor. It adopts one of three defined positions: a neutral one, one to raise the control law by one notch, one to lower the control law by one notch. This mechanism is designed in such a way that when the kinematics law is adjusted, no force is exerted by this control shaft. The control shaft 11 is linked to a part 12, for example via ball bearings or thrust bearings. This part 12 rotates at the same time as the rotor. For each vane mechanism, it actuates, via a blade 12a, a fork 13 by means of a pair of rollers 13a. This fork 13 drives a lever 15 by means of a connecting rod 14. This lever 15 actuates a ratchet wheel 16a secured in rotation with a stabilizing disc 16b provided with peripheral recesses and on which a roller 17a is supported that is carried by a plate 17 and kept under pressure by a spring 18. This last element serves to stabilize the angular position of a shaft 19 without reaction to the upstream control. The shaft 19 ends with a ball screw 19a that makes it possible to move a plate 19b in translation on which the various members are attached at the end of the arm (slotted disc in the case of document WO2017168359A1). To raise or lower the control law from a maximum angle to a minimum angle, the control shaft 11 must be moved several times in the appropriate direction.

It will be noted that FIG. 1A illustrates the case of a one-arm rotor, but the mechanism could be reused in a cassette rotor.

### B—Mechanical Approach in Direct Drive—Cassette Rotor

With reference to FIGS. 1B and 1C, this mechanism is inspired by the mechanical pitch control systems of helicopter anti-torque rotors. At the top of the rotor, we see a fork 151 actuated by an actuator via a connecting rod 152. The fork 151 makes it possible, by means of rollers 153a, to move a control shaft 153 in translation, which rotates with the rotor. At the end of this control shaft 153 is attached a part 154 on which the ends of two connecting rods 155 are attached. The other ends of these connecting rods are attached to L-shaped transmissions 156 pivoting on axes 156a secured to the rotor. On the other ends of these L-shaped transmissions, connecting rods 157 are attached that have respective pins making it possible to rotate the cassette 158 holding the gear trains as well as the slotted discs of the vane inclination controls by a few degrees relative to the body of the rotor.

More precisely, by lifting the shaft 153, the part 156 assumes an oblique orientation, thus shortening the distance in the circumferential direction between the attachment on the connecting rod 155 and the pin 157a. The axis 156a attached to the rotor passes through an oblong slot of the cassette 158 to allow this movement.

By varying this cassette by a few degrees in the body of the rotor, it is easy to understand that the distance between the axes of rotation of the slotted discs and the axes of rotation of the vanes that are fixed in the body of the rotor is varied.

### PART 2— Propulsion Mode—Braking and Stabilization

A person skilled in the art would expect that, in order to brake a ship propelled by a pair of trochoidal-type rotors, the control of the rotors would be reversed so that they jointly exert thrust forward of the ship. However, with reference to FIG. 2, it was unexpectedly discovered that good braking efficiency could be achieved not by directing the flows forward, but to the sides, with the left rotor RG thrusting to the left, preferably at an angle of between 60 and 120° to the left with respect to the ship's axis, and the right rotor RD performing an identical thrust to the right. This approach also makes it possible to substantially limit the stresses applied to the vanes of each rotor.

Conventional braking by directing the flows forward is also possible. It is also interesting in terms of responsiveness because it is not necessary to reverse the direction of rotation of the thruster as on a conventional thruster without variable pitch.

The presence of two rotors (or even two or more pairs of rotors) also makes it possible to control the propulsion of each rotor for the purpose of stabilizing the ship during navigation, in particular to limit its roll by avoiding the use of a bilge keel.

### PART 3— Propulsion Mode—Optimal Flow Orientation

A person skilled in the art would expect that in propulsion with a pair of counter-rotating rotors, the thrust would be optimal if the two rotors exert a thrust on the liquid medium in two directions parallel to each other, along the axis of the boat.

It may be appropriate to use two non-parallel thrust directions for the two rotors. These directions can be divergent or parallel or even convergent.

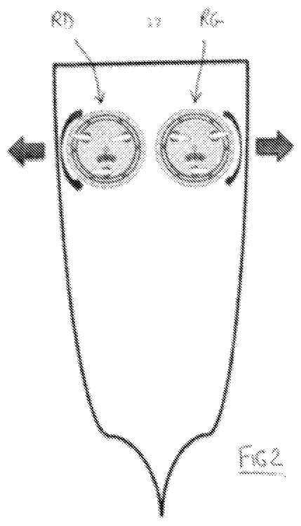

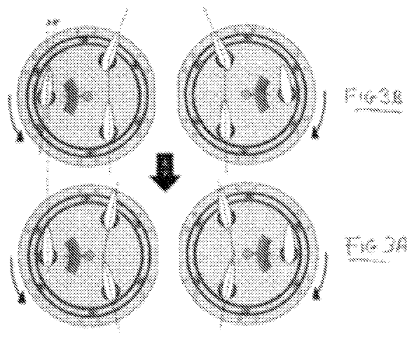

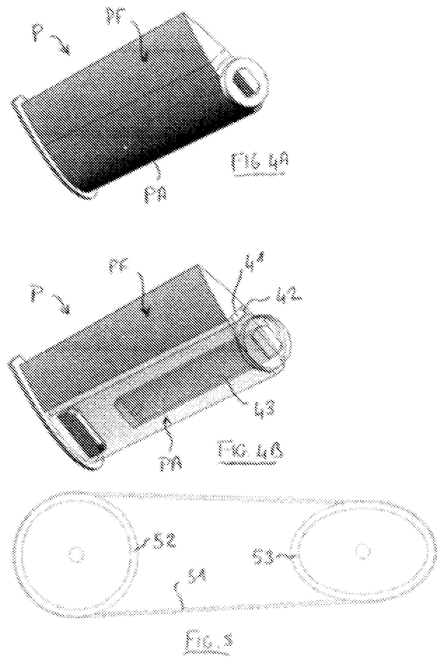

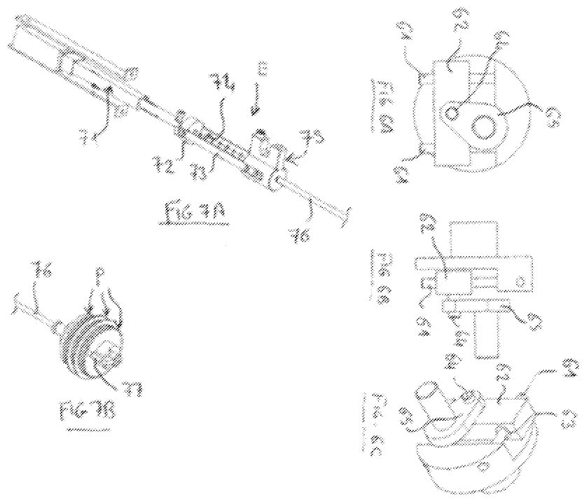

Simulations show that for a given operating point, the flow is not perfectly oriented in the direction of the ship's movement. FIG. 3B thus illustrates an optimum adjustment for a given operating point, which shows a slight pinching (of a few degrees) of the setting laws so as to optimally direct the flows generated by the thrusters, compared to the case of FIG. 3A where there is no pinching.

In one approach, diverging directions can be provided for slow speeds, and converging directions for fast speeds. It is also possible to adjust the angle of convergence/divergence according to the level of disturbance that is acceptable for the aquatic environment, or even the maneuverability of the ship.

### PART 4— all Applications—Elastically Deformable Vanes

According to this improvement, the rotor vanes are, at least over part of their extent, elastically deformable in bending so that their profile can deform. This makes it easier to loosen the streams of water and to substantially increase the aero- or hydrodynamic performance of the vanes.

This deformability can be obtained by using a homogeneous elastically deformable material for the vanes, in which case their thinner thickness as one approaches the trailing edge makes them more easily deformable in this region. This arrangement makes it possible to improve the fluidity of operation, to limit the mechanical stresses applied to the vanes and to improve efficiency.

FIGS. 4A and 4B illustrate (the view of FIG. 4B being semi-transparent) an embodiment of a semi-deformable vane P: only the region of the trailing edge PF of the vane is made of a deformable material (e.g. rubber, reinforced or not). According to one embodiment, this flexible part can be threaded via a dovetail 41 into a complementary forge 42 provided at the rear of the leading part PA of the vane, which is rigid. Bonding can also be considered if the materials allow it.

The location of the transition zone between these two parts can be chosen depending on the application, and will typically be located between ⅓ and ⅔ of the length of the vane between the leading edge and the trailing edge.

Reference numeral 43 designates an armature of the vane, embedded in the leading part PA.

PART 5— all Applications—Control of the Maximum Angle of the Vanes without Eccentric

With reference to FIG. 5, illustrated is a control of the tilting of the satellite or nacelle associated with each vane no longer by an eccentric movement, but by a non-slip transmission (chain, toothed belt, etc., designated by the reference numeral 51) in which one of the pinions 52 is circular, and the other pinion 53 is non-circular—for example ovoid or elliptical, with the same number of teeth or notches as the circular pinion. One of the pinions is on the main axis of the rotor, without the possibility of rotation, while the other pinion (satellite) is directly engaged with the axis of the vane. It is understood that during the rotation of the rotor, the tilting of the vane is caused by the difference in angular path of the satellite pinion with respect to the central pinion, linked to the fact that the local radius of one of the pinions varies continuously while the local radius of the other pinion always remains constant.

If necessary, a chain or belt tensioner is provided to compensate for variations in the development of the chain/belt in its contact area with the non-circular pinion when the latter rotates.

A particularly simple and economical control of the angle of the vanes is achieved.

The non-circular pinion 53 can either be on the axis of the rotor, or be the satellite.

This approach requires that the circumference of the ellipse and the circumference of the circle be strictly identical so as not to create a desynchronization of the kinematics (for example, with a chain or belt transmission, by providing the same number of teeth or notches on both items).

Its main advantage is simplicity in terms of the number of parts, in the case where a constant setting law is appropriate. It is understood that the smaller the aspect ratio of the ellipse, the less the setting law will have a significant angle, and vice versa. It can be provided in addition, for example by taking inspiration from bicycle derailleurs, to be able to pass from one elliptical pinion to another with a different aspect ratio in order to vary the setting law.

### PART 6— all Applications—Pin and Slot Mechanism Play Compensation

In document WO2017168359A1, play may occur, in particular due to wear, between each pin and the slot in which it slides, in particular creating jerks in the movement of the vanes. To remedy this, provision is made for each pin to be provided with a play compensation function, for example by comprising a series of elements held together by a cage and elastically urged outwards by an elastic means such as a spring.

Alternatively and with reference to FIG. 6A-6C, the groove or slot C described in document WO2017168359A1 is replaced by a linear displacement carriage 62 on which the pin 64 equivalent to the pin D of WO2017168359A1 is pivotally mounted.

This carriage 62 here is slidably mounted on two rods 61 preferably by means of elements 63 with little or no play, such as bearings or ball bearings. The pin 64 is mounted eccentrically on a crank pin 65 functionally corresponding to the disc B of document WO2017168359A1.

In the illustrated embodiment, the pin 64 is guided along a rectilinear path. A different path can be provided by changing the shape of the guide rods 61.

### PART 7— Securing and Resetting

Document WO2017168359A1 describes feathering with a groove and key mechanism operable electromechanically or purely mechanically, thus completely releasing the rotating vanes and thus neutralizing the operation of the machine.

Proposed here is a device allowing securing and automatic resetting of the rotor, based on an automatic locking/unlocking key operating between the shaft of the rotor and each pulley (or pinion in the case of a chain or gear transmission) arranged on the axis of the rotor and allowing control of the variations in inclination of the respective vane.

When securing must be activated, for example in the event of wind exceeding a threshold for wind turbine applications, a linear actuator such as an electric jack acts on a rod that allows the key to be disengaged, as will be seen in detail later.

When it is decided to reset, the actuator returns to its initial position. It does not pull on the central rod directly, but via a spring, which allows the key to exert pressure on the first pulley to be reengaged. According to one embodiment, it is possible to arrange a cam follower or any other sliding element facilitating the sliding of the key on the surface of the pulley. The pulley of the first vane can be reset based on the wind, but it may be preferable to activate the mechanism for controlling the orientation of the rotor according to the orientation of the wind (yaw actuator) to make the central yaw control (pulley support part) perform several successive turns and thus ensure passage of the key in the groove of the respective pulley. This reset procedure implies that there is a sufficient wind level to maintain each vane, and therefore its associated axial pulley, in a given position while the central part supporting the key rotates owing to the yaw actuator). The control spring is preloaded in such a way that the successive resetting of the various axial pulleys is carried out until the machine is completely reset.

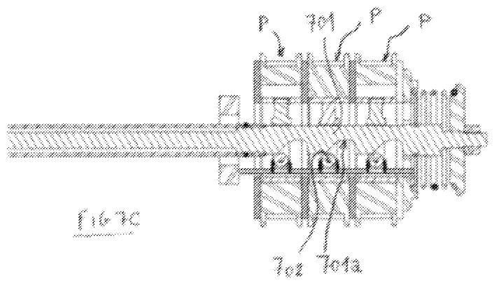

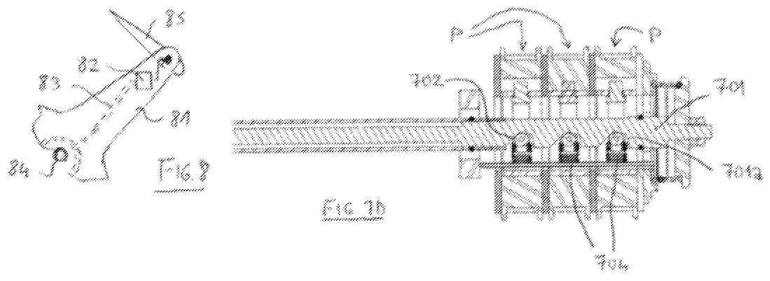

FIGS. 7A and 7B illustrate a particular embodiment of this securing and reset system. An actuator 71 controls the whole assembly E made up of parts 72, 73 and 74 in translation. The assembly E is locked in rotation by a part 75 that slides in a slot linked to the body of the base of the rotor (not shown here). The assembly E drives a safety rod 76 in translation that forms, at its free end, a key 77 that is housed in or comes out of housings made in the axial pulleys of the rotor and that allows them to be locked in rotation or not. Thus, when the key is disengaged, the mechanisms are disengaged, the pulleys are free to rotate and the vanes also become free to rotate, which in particular allows feathering in the event of excessive wind.

In the other direction, for resetting, the assembly E acts on the rod 76 via a compression spring 74. Thus, when this spring is compressed, the reset procedure can be initiated: the yaw actuator rotates a central part 78 of the rotor that holds the pulleys until the key finds itself, sequentially, in line with the housings of the associated pulleys. The key then shifts stepwise, by a pitch equal to the thickness of the pulley, successively until all the pulleys are reset in rotation.

FIGS. 7C and 7D illustrate another pulley locking system. This mechanism is similar to a clutch system with indexing of the elements to be locked, here the pulleys. It comprises a main key 701 having here three housings 701a that make it possible to release or retain three indexing pins 702 forming secondary keys. These are arranged to be able to be housed in grooves formed in the respective pulleys P. Depending on the position of the key, in one case (FIG. 7C) it withdraws the pins 702 from the housings of the pulleys, in the other case (FIG. 7D) it releases the pins 702, which tend to press, owing to respective springs 704, toward the inside of the pulleys. Between each pair of pulleys, friction elements are advantageously provided such as washers made of material of the type used for vehicle brake pads.

When the key is in the disengaged position, it completely decompresses an end spring, which thus allows each pulley to be free in relation to the others. When the resetting procedure is engaged, the key initially descends sufficiently to release the pins. The resetting procedure with the yaw actuator is then launched so as to cause the central part 701 that holds the pins 702 to pass in front of the grooves of the pulleys. Once this step has been completed, the key is pulled to its engagement position by compressing the spring at this time, which makes it possible to secure the assembly. The advantage of this solution lies in the fact that the forces during operation no longer pass through the key and its housings in its pulleys, which makes it possible to glimpse increased reliability.

### PART 8— Offset of the Pitch Control to the End of the Arms

While in WO2016067251A1 and WO2017168359A1, the control of the maximum angle variation of the vanes is carried out in a common way from a central action (typically by angular control about the main axis of the rotor, WO2017168359A1), here an individual maximum angle variation control 82 is carried out at the end of each arm 81.

This control can be electromechanical, with an actuator individually controlling, for example, the position of the axis of the slotted element relative to the axis of the pin element according to the mechanism of WO2017168359A1.

The power supply of such an actuator, as well as the control instructions that can be implemented by carrier currents, can be conveyed (reference numeral 83) owing to sliding contacts at the main axis 84 of the rotor. Alternatively, it is possible to provide wireless energy transmission by magnetic coupling if the necessary electric power of the satellite control allows it.

With such an individual control, it becomes possible to generate any control law for the inclination of the vane 85, in particular programmable, in particular in order to optimize the efficiency of the machine both in generator mode and in thruster mode.

### PART 9—Belt Transmission—Maintaining Belt Tension

A toothed belt transmission between central pinion and satellite pinion is advantageous in particular in terms of simplicity and cost, and on large rotor dimensions. However, as the speed increases, it may be necessary to increase the tension of the belt, which may begin to have unwanted beats.

This increase in tension can be achieved, for example, by a flyweight device subjected to centrifugal force and exerting a displacement on a tensioning member that is all the greater as the speed of rotation is high.

FIG. 9 illustrates an example of this mechanism. A tension holding pulley 91 is applied to the belt 96 by being mounted on a plate 92 that pivots on an axis 93 attached to an arm 94 of the rotor. A weight 95 is mounted at the end of the plate 92. It is understood that with the increase in the speed of rotation of the rotor, the flyweight formed by this weight 95 generates a force directed toward the outside of the rotor under the effect of centrifugal force, which makes it possible to increase the pressure of the tension pulley 91 on the belt 96. The various parameters are determined in such a way as to ensure a satisfactory tensioning level.

### PART 10—Belt Transmission—Maximum Vane Inclination Adjustment

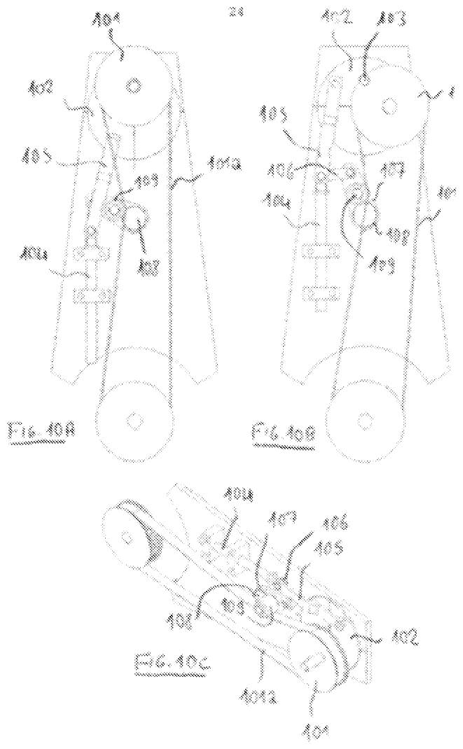

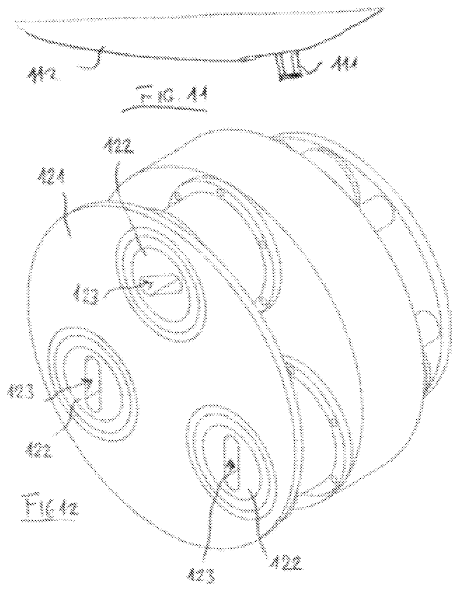

As we have seen above and in document WO2017168359A1, in order to achieve a variation in the vane setting control law in real time, it is necessary to vary the distance between the axis of rotation of the vane and the axis of rotation of the slotted disc or its equivalent. It seems complicated to vary the point of rotation of the vane on the rotor, so we are interested in varying the position of the slotted disc and its equivalent. In this case, the distance between the central control pulley and the pulley at the end of the arm varies, which causes the belt (or chain) to relax when this distance decreases. A system to overcome this difficulty is described here with reference to FIG. 10A-10C. The slotted disc is attached on the pulley 101 located at the end of the arm, engaged with the belt 101a. This pulley 101 is mounted via ball bearings on an eccentric 102. It is understood that by rotating this eccentric, the distance of the axis of rotation of the slotted disc with respect to the axis of the vane represented by the axis 103 is modified. A control rod 104, actuated by a mechanism as described in the present application or in one of documents WO2014006603A1, WO2016067251A1 and WO2017168359A1, can be moved in translation. This control rod 104 makes it possible, via a connecting rod 105, to adjust the angular position of the eccentric. However, it also makes it possible, via a second connecting rod 106, which according to this embodiment is attached on the same axis as the connecting rod 105, to pivot a plate 107 that pivots about an axis 108 and that holds a tension roller 109. The geometry of the various members is determined so that the roller 109 maintains a satisfactory tension of the belt 101a whatever the angular adjustment of the eccentric.

It is possible, according to an alternative embodiment, to provide an automatic spring tensioning device attached to the plate 107 or else a tensioning device attached directly to the arm.

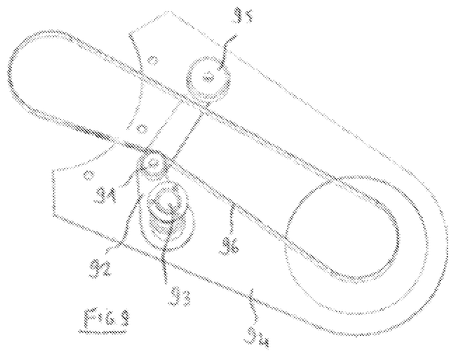

In this case, a version with conical bevel gears is selected (see FIG. 8B of document WO2014006603A1) instead of a belt and pulley mechanism; the shift in translation of the slotted disc should ideally take place on a radius of the rotor. The connecting axis between the central bevel pinion and the bevel pinion on the satellite side is then splined on the satellite side at the meshing of the slotted disc. This allows the movement in translation, along a radius of the rotor, of the plate supporting the slotted disc and the bevel pinion by sliding on the spline of the connecting shaft.

### PART 11—Mixed Use in Nautical Application

Document WO2016067251A1 describes the use of a rotor in propulsion mode to propel a drone or marine craft, and in generator mode when the craft is moored, to generate electricity on board by using marine currents. With reference to FIG. 11, when sailing, the vanes 111 can be either free so as to immediately adapt to the orientation of the water flow while minimizing drag, or kept fixed and preferably in the axis of the boat 112, with their leading edge toward the bow, so as to generate a keel or centerboard effect.

Another possibility is to orient the vanes by enslaving them to the rudder (in the case where the rotor is toward the rear of the boat) so as to assist the boat during tacks to give them an auxiliary rudder function.

### PART 12—Replacement of Vanes

According to an advantageous aspect, a mechanism can be provided allowing the easy replacement of a broken or damaged vane.

This applies particularly to the assembly of the vanes in cantilever, whether in generator mode or in propulsion mode.

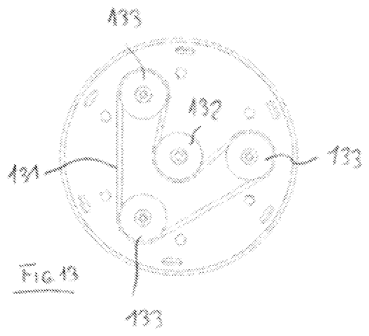

With reference to FIG. 12, each vane structure thus comprises an axis forming a projecting armature (not shown) that is inserted into a sleeve 123 formed in a plate 122 associated with the respective vane, the plates being rotatably mounted in a support structure 121.

The connection in translation along the direction of the axis can be carried out by any mechanical means such as keying, clipping, screwing, or any combination of these solutions. Rotational securing is achieved here by giving the armature axis of the vane and its housing a non-circular cross-section, here oblong.

According to one embodiment, the slotted discs that drive the vanes (see document WO2017168359A1) have hollow shafts, an inspection hatch being arranged above the rotor so as to be able to pass a key so as to screw a nut that holds a threaded pin extending the vane axis of oblong section. Beforehand, the angular position of the rotor is adjusted to its neutral position (setting angle at 0°) so that the vane axes are aligned with the axes of the slotted discs.

### PART 13—Single Belt or Chain

With reference to FIG. 13, an embodiment has been illustrated in which a set of three belts respectively connecting three central pulleys secured in rotation with the axis of the rotor (unless disarmed) to three satellite pulleys, is replaced by a single belt 131 ensuring the engagement of a single axial pulley 132 with three satellite pulleys 133 respectively associated with the mechanisms for varying the inclination of three vanes (not shown).

Such an approach makes it possible to reduce the axial bulk of the control part of the rotor.

Of course, the various inventions described above and shown in the drawings may be subject to numerous modifications and variants. Furthermore, the different inventions can be combined together by those skilled in the art, these combinations being considered as part of the present description.

Furthermore, in propulsion application, a rotor according to one of documents WO2014006603A1, WO2016067251A1 and WO2017168359A1 or according to one of the improvements of this specification can be used for a vehicle that is manned or not, submerged or not. For a submerged vehicle of generally tapered shape, it is possible to provide several rotors having axes of rotation arranged in a star shape in a plane transverse to the direction of movement. For a vehicle with foils, a rotor can be integrated into a foil by giving it an appropriate width.

1. Rotor with adjustable vanes, comprising a rotary structure rotating about a main axis and comprising a set of vanes rotating about a series of vane axes parallel to the main axis and defined by said rotary structure, and a mechanism associated with each vane and configured to control the variations in inclination of the associated vane according to the angular position of the rotary structure, this mechanism comprising a first element (65) supporting a pin (64) and a second element that is eccentric with respect to the first and configured to channel the movements of the pin along an imposed path, the rotor being characterized in that said path is imposed by the translational movements of a carriage (62) along one or more guides (61) provided on the second element.

2. Rotor according to claim 1, characterized in that the carriage is mounted on two rods (61).

3. Rotor according to claim 1 or 2, characterized in that the carriage is mounted on the guide(s) (61) by means of play-free sliding elements (63), in particular ball bearings.

4. Rotor with adjustable vanes, comprising a rotary structure rotating about a main axis and comprising a set of vanes rotating about a series of vane axes parallel to the main axis and defined by said rotary structure, and a mechanism configured to control the variations in inclination of the vanes according to the angular position of said structure, according to a setting law, said mechanism comprising, for each vane, a transmission in a generally radial direction between a driving element rotating with the rotor and a driven element driven eccentrically at the vane, characterized in that it comprises means for varying the setting law by means of a central control comprising a control element able to move along the main axis and a set of return elements able to generate a displacement of the driven elements respectively associated with each vane.

5. Rotor according to claim 4, characterized in that said displacement is a sequentially controlled radial displacement.

6. Rotor according to claim 4, characterized in that said displacement is a continuously controlled circumferential displacement.

7. Watercraft, comprising a pair of main thrusters comprising counter-rotating rotors, each rotor with adjustable vanes comprising a rotary structure rotating about a main axis and comprising a set of vanes rotating about a series of vane axes parallel to the main axis and defined by said rotary structure, and a mechanism for controlling the variations in inclination of said rotary structure according to its angular position so as to exert thrust on the water in a determined direction, characterized in that means are provided for directing the thrust of the two rotors in two generally opposite lateral directions in order to ensure braking of the vehicle.

8. Vehicle according to claim 7, characterized in that it further comprises at least one bow thruster.

9. Vehicle according to claim 7 or 8, characterized in that it also comprises at least one secondary thruster.

10. Watercraft, comprising a pair of thrusters comprising counter-rotating rotors, each rotor comprising a rotary structure rotating about a main axis and comprising a set of vanes rotating about a series of vane axes parallel to the main axis and defined by said rotary structure, and a mechanism for controlling the variations in inclination of said rotary structure according to its angular position so as to exert thrust on the water in a determined direction, characterized in that thrust correction means are provided that are capable of adjusting the thrust direction of each rotor on either side of a direction located along the main axis of the vehicle.

11. Rotor with adjustable vanes, comprising a rotary structure rotating about a main axis and comprising a set of vanes rotating about a series of vane axes parallel to the main axis and defined by said rotary structure, and a mechanism for controlling the variations in inclination of said rotary structure according to its angular position, characterized in that each vane is at least partially elastically deformable.

12. Rotor according to claim 11, characterized in that each vane comprises an essentially non-deformable leading part and an elastically deformable trailing part.

13. Rotor with adjustable vanes, comprising a rotary structure rotating about a main axis and comprising a set of vanes rotating about a series of vane axes parallel to the main axis and defined by said rotary structure, and a mechanism for controlling the variations in inclination of said rotary structure according to its angular position, said mechanism comprising, in association with each vane, a driven element (53) synchronized with a corresponding driving element (52) located on the axis of the rotor via a link (51) closed on itself such as a toothed belt or a chain, characterized in that one (52) of the elements is circular, and the other element (53) is non-circular, with a number of notches or teeth identical to that of the circular element, so as to directly ensure variations in the angular position of the vanes during the rotation of the rotary structure.

14. Rotor according to claim 13, characterized in that the other element (53) is elliptical.

15. Rotor according to claim 13 or 14, characterized in that it comprises a tensioning device for the link.

16. Rotor according to one of claims 13 to 15, characterized in that it comprises a set of non-circular elements (53) of different aspect ratios, and a device for passing the link from one non-circular element to another.

17. Wind turbine, characterized in that it comprises a rotor according to one of claims 13 to 16.

18. Watercraft, characterized in that it comprises a pair of thrusters each comprising a rotor according to one of claims 13 to 16.

19. Rotor with adjustable vanes, comprising a rotary structure rotating about a main axis and comprising a set of vanes rotating about a series of vane axes parallel to the main axis and defined by said rotary structure, and a mechanism associated with each vane for controlling the variations in inclination of said vane according to the angular position of said rotary structure, said mechanism comprising a set of generally radial transmissions between driving elements arranged adjacent to the axis of the rotor and each of said mechanisms, characterized in that it further comprises a release and resetting mechanism comprising a key able to move along the axis of the rotor with respect to said driving elements.

20. Rotor according to claim 19, characterized in that said release mechanism comprises a key able to selectively come into direct engagement with each of the driving elements and urged by an elastic means acting along the axis of rotation of the rotor to sequentially come into engagement with each of said driving elements when they are rotated.

21. Rotor according to claim 19, characterized in that said release mechanism comprises a main key capable of selectively urging a set of secondary keys that in turn are elastically urged in a direction transverse to the axis of the rotor and respectively come into engagement with the respective drive elements.

22. Rotor with adjustable vanes, comprising a rotary structure rotating about a main axis and comprising a set of vanes rotating about a series of vane axes parallel to the main axis and defined by said rotary structure, and means for controlling the variations in inclination of each vane according to the angular position of the rotor, characterized in that said means comprise a set of individual actuators controlled non-mechanically from the rotor to vary individually in a potentially adjustable manner and potentially program the pitch variations of the associated vane.

23. Rotor with adjustable vanes, comprising a rotary structure rotating about a main axis and comprising a set of vanes rotating about a series of vane axes parallel to the main axis and defined by said rotary structure, and a mechanism for controlling the variations in inclination of said rotary structure according to its angular position, said mechanism comprising, in association with each vane, a driven element synchronized with a corresponding driving element located on the axis of the rotor via a link closed on itself such as a toothed belt or a chain, characterized in that it comprises a mechanism for holding each link under tension.

24. Rotor according to claim 23, characterized in that said tension holding mechanism comprises a movable element in contact with said link and subjected to the centrifugal force generated by the rotation of the rotor.

25. Rotor according to claim 23, characterized in that the tension holding mechanism comprises a movable element in contact with said link and subject to a movable member aimed at varying the maximum amplitude of the variations in inclination of the associated vane.

26. Watercraft, in particular a sailboat, is proposed, comprising an engine coupled to an immersed rotor with adjustable vanes, said rotor comprising a rotary structure rotating about a main axis and comprising a set of vanes rotating about a series of vane axes parallel to the main axis and defined by said rotary structure, and a mechanism for controlling the variations in inclination of said rotary structure according to its angular position, characterized in that the rotor has a first operating mode as a thruster while being driven by the engine, and a second drift or rudder operating mode.

27. Rotor with adjustable vanes is proposed, comprising a rotary structure rotating about a main axis and comprising a set of vanes rotating about a series of vane axes parallel to the main axis and defined by said rotary structure, and a mechanism for controlling the variations in inclination of each vane according to the angular position of said rotary structure, each vane being mounted cantilevered on said rotary structure, characterized in that quick mounting devices are provided for mounting the vanes on rotary supports subject to said mechanism.

28. Rotor according to claim 27, characterized in that each vane comprises an armature of non-circular cross-section extending over a substantial part of its extent, said armature projecting at a longitudinal end of the vane for mounting thereof on a respective rotary support.

29. Rotor with adjustable vanes, comprising a rotary structure rotating about a main axis and comprising a set of vanes rotating about a series of vane axes parallel to the main axis and defined by said rotary structure, and a mechanism for controlling the variations in inclination of said rotary structure according to its angular position, said mechanism comprising, in association with each vane, a driven element synchronized with a driving element located on the axis of the rotor via a link closed on itself such as a toothed belt or a chain, characterized in that a single link is provided between a single driving element located on the axis of the rotor and said driven elements.
